(19) United States
(12) Patent Application Publication
(10) Pub. No.: US 2003/0036945 A1
(43) Pub. Date: Feb. 20, 2003

(54) System, method and computer program product for assessing the value of intellectual property

(76) Inventors: Joseph Nicholas Del Vecchio, Aurora, NY (US); John Michael Del Vecchio, Orchard Park, NY (US); Kenneth Michael Gossel, West Seneca, NY (US)

Correspondence Address: John M. Del Vecchio, 7016 Milestrip Road, Orchard Park, NY, 14127, US

(21) Appl. No.: 09/862,950

(22) Filed: May 22, 2001

(51) Int. Cl. G06F 17/60

(52) U.S. Cl. 705/10

(57) ABSTRACT

A method for assessing the value of a company's intellectual property comprising the steps of gathering intellectual property data, performing an assessment of the intellectual property data and generating a report based on the assessment of the intellectual property data. A system and computer program product for assessing the value of a company's intellectual property comprising means for gathering intellectual property data, means for performing an assessment of the intellectual property data and means for generating a report based on the assessment of the intellectual property data.

### BACKGROUND

Presently, fantastic amounts of capital are moved, traded and held in financial markets. These markets include both debt and equity market sectors. The debt market primarily encompasses the issuance and trading of corporate and government bonds, and the equity market primarily encompasses the issuance and trading of equity shares of various corporations and mutual funds. The debt and equity markets are often referred to collectively as the securities markets. With respect to the equity market, much of the capital is held in the form of shares of stock in individual companies, while other portions of this capital may be in the form of shares of mutual fund companies. Mutual funds may be industry specific, that is, they may be dedicated to a particular industry or particular sector of the market. Examples of industry specific mutual funds are funds that concentrate assets in the health care sector, the telecommunications sector, the pharmaceutical sector, the computer and high tech sector, and so forth.

Brokerage houses, stock market analysts, mutual fund managers, and others presently have significant difficulty in assessing the valuation of the intellectual property aspect of their security holdings. In particular, what is the value of the patents, trademarks, copyrights, and technical licenses owned by the companies in which the brokerage houses and mutual fund managers invest in, in terms of real worth? The answer to this difficult question can potentially make or break a mutual fund or brokerage house, and accurate assessment of the valuation of intellectual property can vastly improve the profits generated by mutual funds and brokerage houses. In addition, such information is of great use to others for strategic evaluation of the competition or identification of potential acquisition targets.

Attempts have been made in the past to evaluate data regarding patents. For instance, U.S. Pat. No. 6,175,824 B1 (hereinafter the '824 patent) discloses a method for choosing a stock portfolio based on patent indicators. However, this invention simply teaches an automated stock selection tool in which stock selections are made only on the basis of very limited information, designated in the reference as patent indicators. The invention fails to disclose a method for combining patent indicators with other financial information on a company to assist a stock market analyst in the making of short or long term investment decisions with respect to a particular company or security. Moreover, while the '824 patent describes several limited patent indicators, such as the number of patents issued per year, and frequency of patent citations, the invention does not disclose or suggest a tool for assessing the overall future power of a patent, the present patent strength of a corporate patent portfolio, or claim analysis techniques.

Similarly, U.S. Pat. No. 5,991,751 (hereinafter the '751 patent) discloses a general technique for combining data from a first database of patents with data from a second database of non-patent information. However, the invention disclosed therein does not teach or disclose how such information could be presented in a meaningful fashion to market analysts or others in need of such data for financial investment decisions. In addition, the '751 patent does not teach or suggest a tool for assessing the overall future power of a patent, present patent strength, or claim analysis techniques. Rather, the invention is directed toward data processing and combination techniques of multiple sets of data stored in databases. It discloses a database management mechanism, but does not teach or suggest meaningful analysis tools for market analysts and other end users.

### BRIEF SUMMARY OF THE INVENTION

The present invention provides a system, method and computer program product for assessing the value of the intellectual property of a company, business, corporation or other entity, such that the information produced by the present invention may be used to fairly and accurately assess the value of the company as a whole. This overcomes problems and limitations of the prior art and provides users with a useful and understandable report. The system, method and computer program product calls for the careful examination of the patent, trademark, copyright, technical license and other components of the intellectual property portfolio of the company under examination, and generates an output report based on a thorough assessment of each such component to determine strengths and weaknesses of the portfolio in view of market demands, time remaining until patents expire, relevant prior art, pending patent applications, international patents, specific patent claim language and so forth. The output report generated by the assessment can be readily accessed by the company that owns the intellectual property, the brokerage house that holds shares or wants to buy shares in the company but wants to make a well reasoned decision on behalf of its clients, mutual fund managers that must have access to reliable information before buying or selling shares in a particular company, stock market analysts or other financial advisors who must have access to reliable information prior to providing clients with prudent investment advice, as well as others involved in corporate strategic research.

### DETAILED DESCRIPTION OF THE DRAWINGS

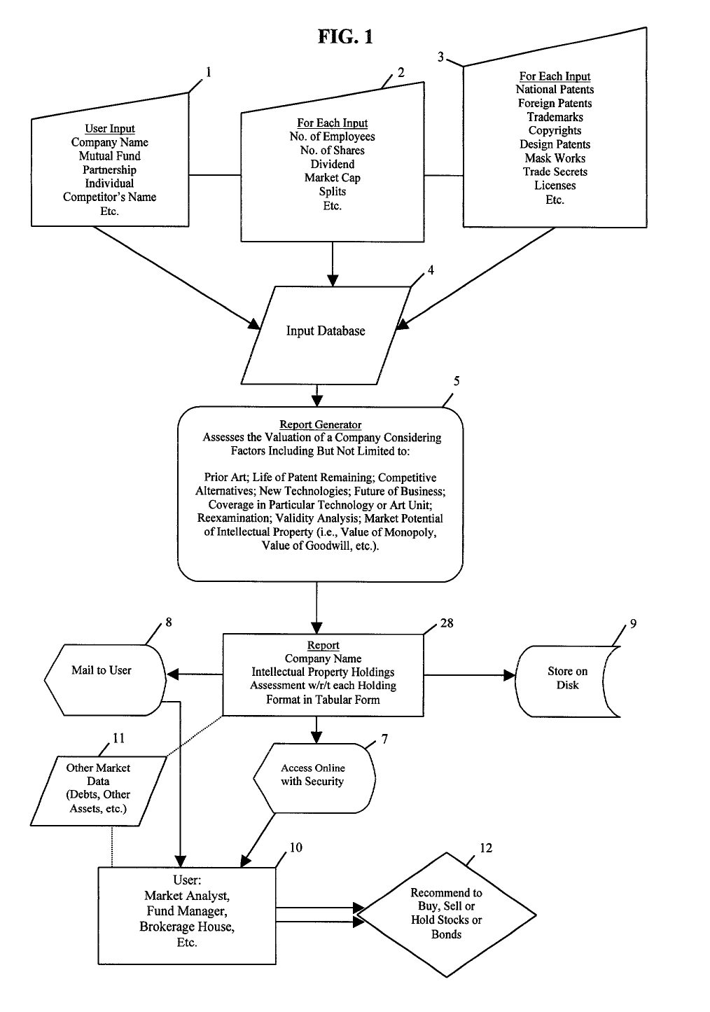

FIG. 1—The architecture of the computer program for assessing the value of an intellectual property portfolio of a company, such flow chart may be embodied in a computer software program product.

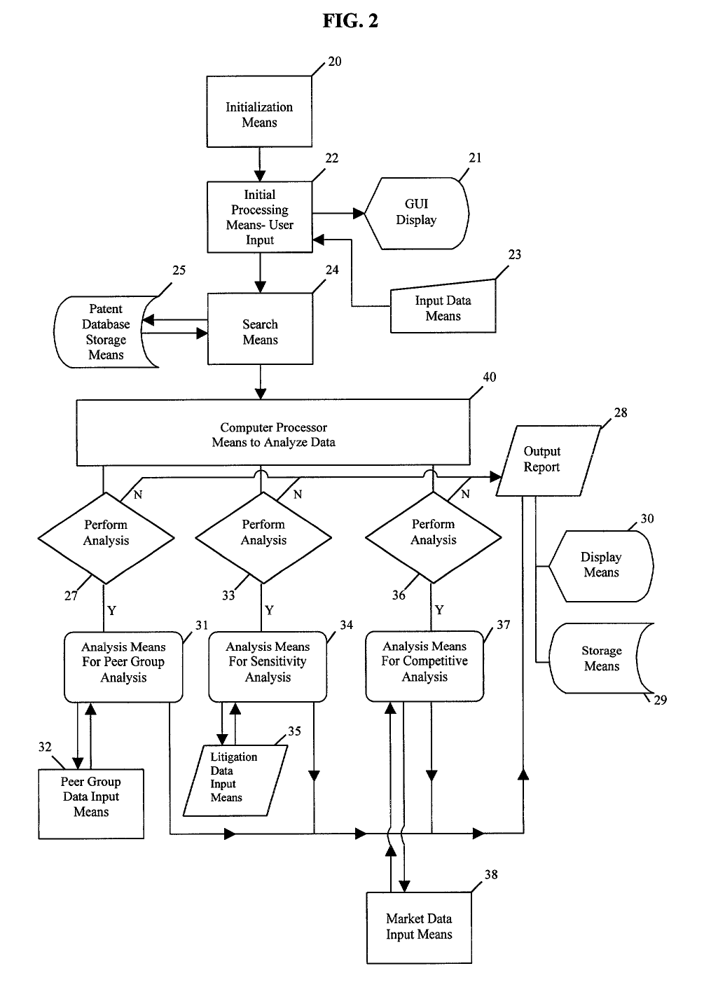

FIG. 2—A block diagram of the overall operation of a computer software program for assessing intellectual property holdings.

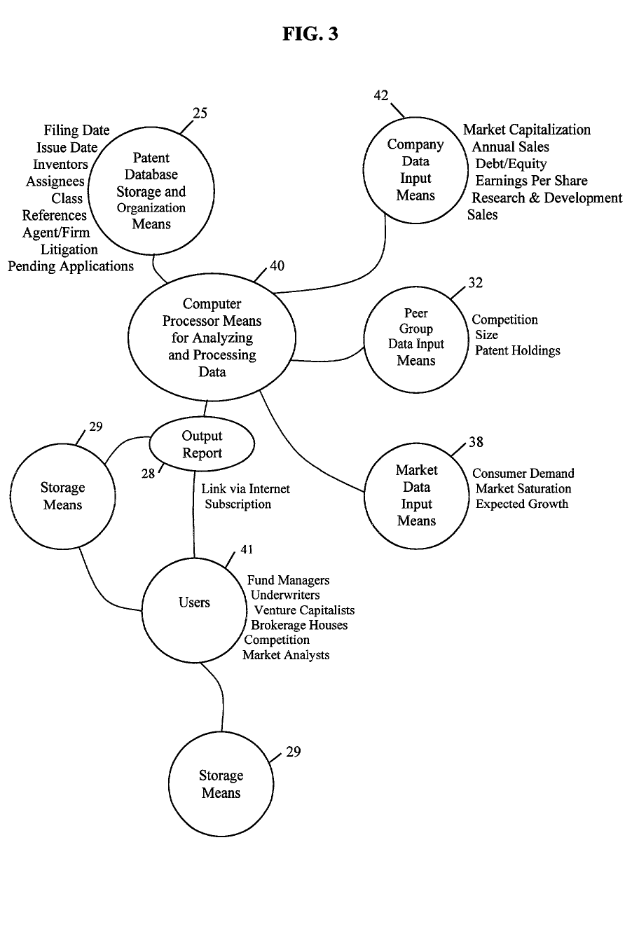

FIG. 3—An entity relationship diagram representing the general relationship of the database means, computing means and storage means for a data processing system for assessing the intellectual property portfolio of a company.

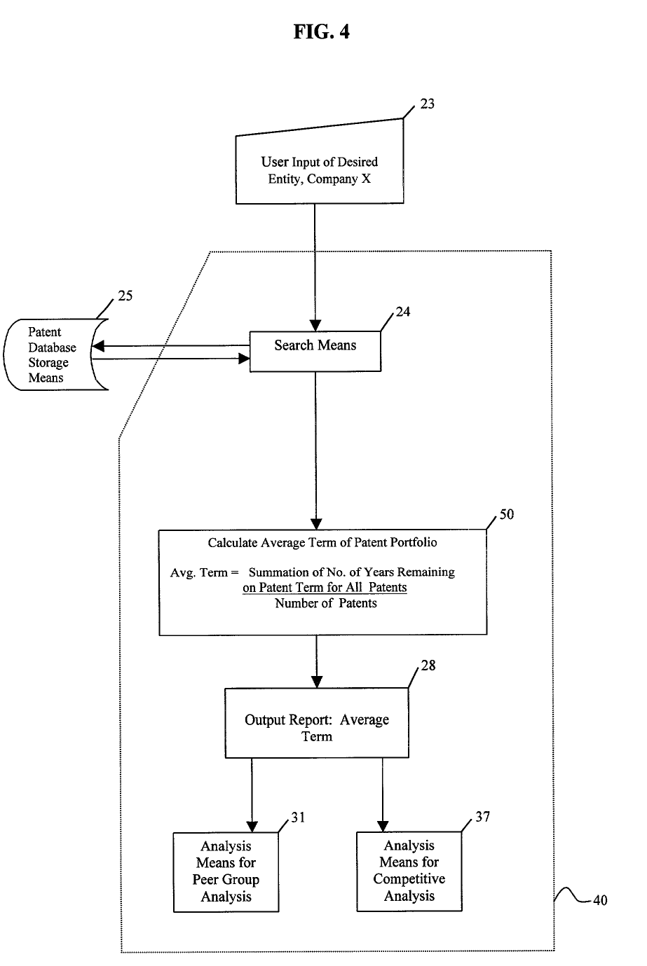

FIG. 4—A block diagram of the arithmetic logic circuit of a computer software program configured to calculate the Average Patent Term remaining on patents in a patent portfolio owned by a company, store results and perform comparative analysis.

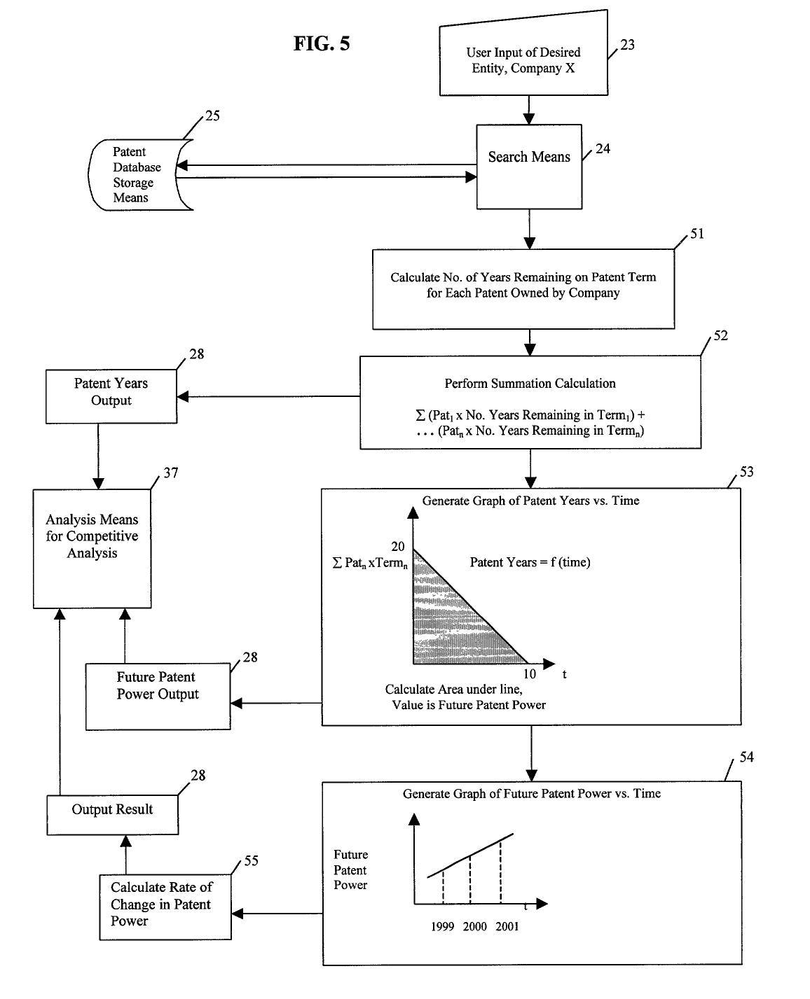

FIG. 5—A block diagram of the arithmetic logic circuit of a computer software program configured to calculate the number of Patent Years and Future Patent Power of a company's patent portfolio, calculate incremental increases or decreases in Future Patent Power, store results and perform comparative analysis.

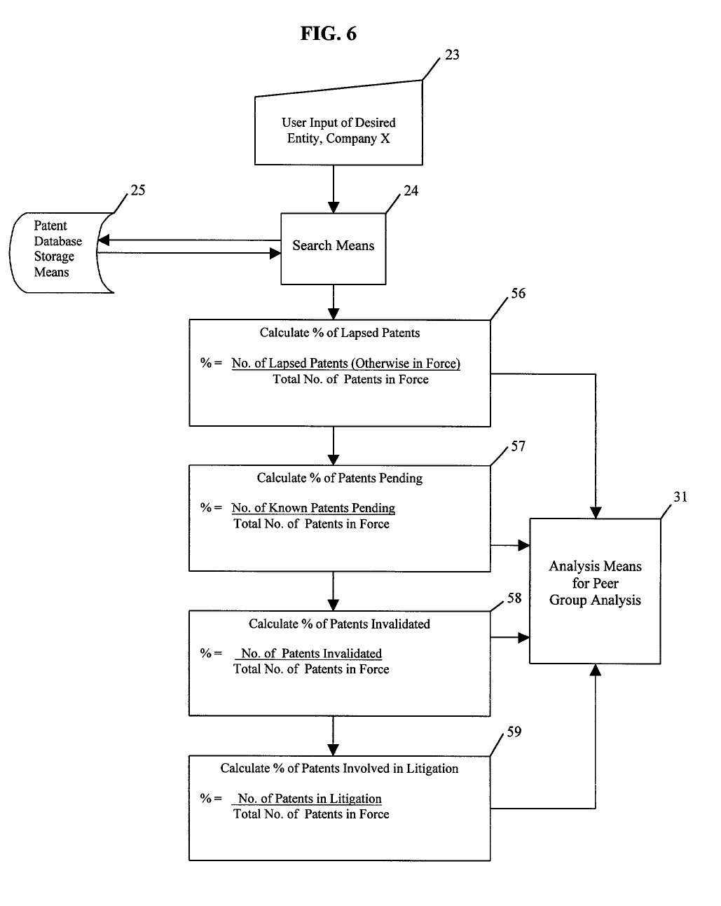

FIG. 6—A block diagram of the arithmetic logic circuit of a computer software program configured to calculate the number of patents pending, instances of pending patent litigation, lapsed patents and other factors of a company's patent portfolio, store results and perform comparative analysis.

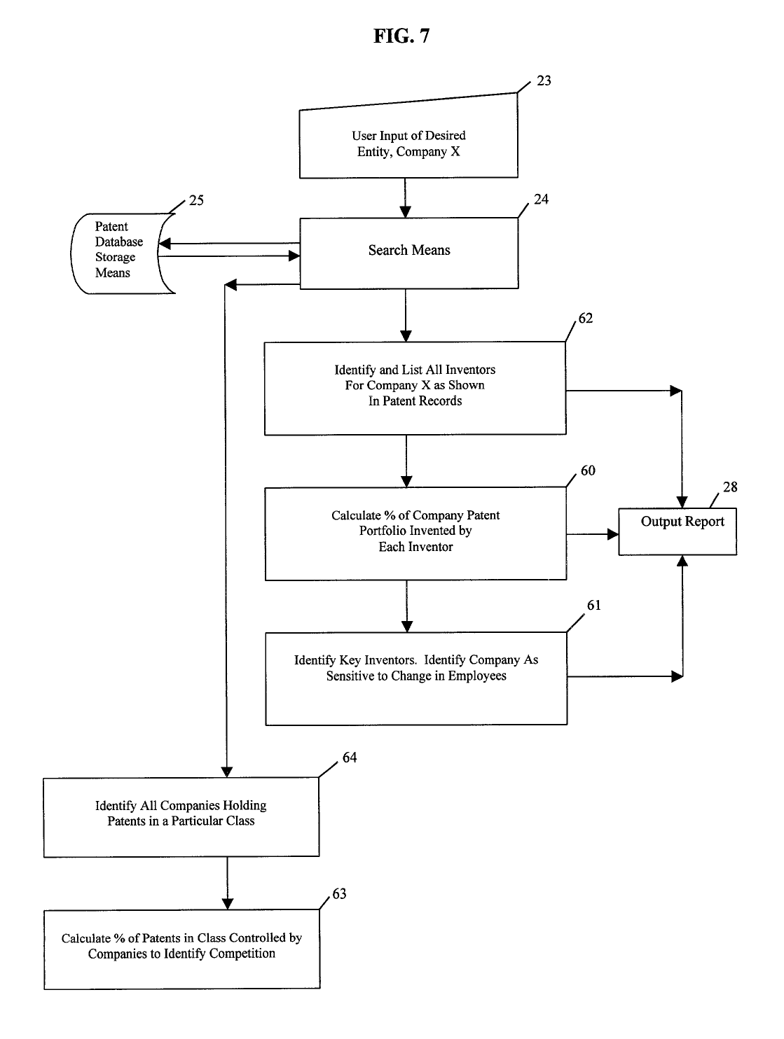

FIG. 7—A block diagram of the arithmetic logic circuit of a computer software program configured to calculate statistical data regarding the identity of the inventors of the patents contained in a company's patent portfolio, store results and perform comparative analysis.

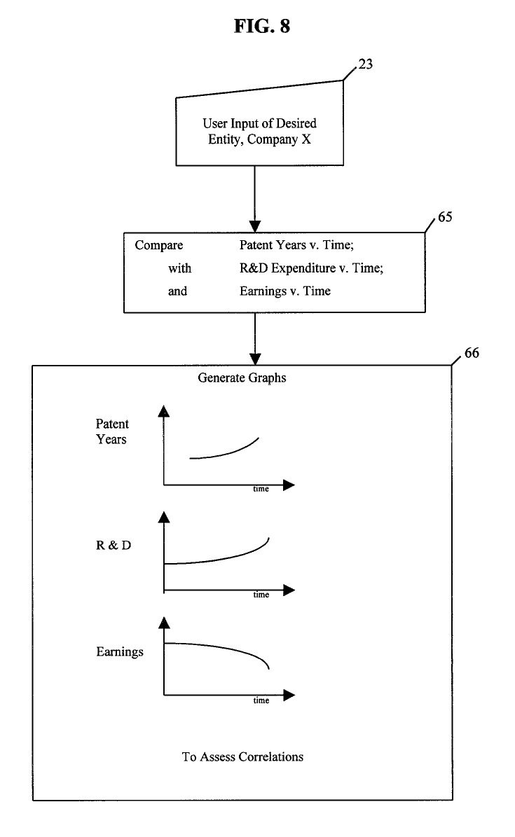

FIG. 8—A block diagram of the arithmetic logic circuit of a computer software program configured to calculate incremental changes in Patent Years of a company, store results and perform comparative analysis.

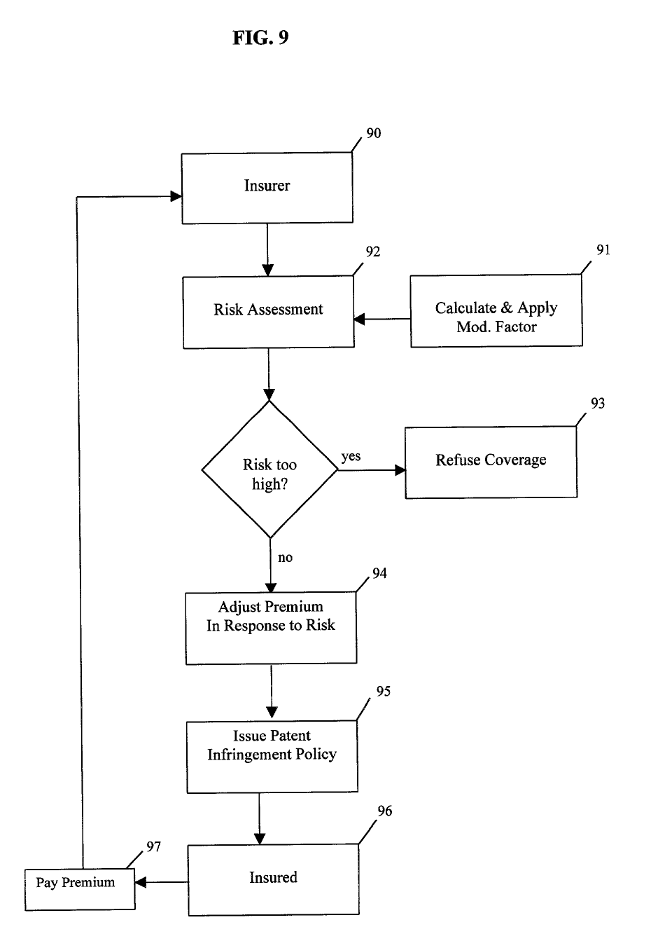

FIG. 9—A block diagram of the arithmetic logic circuit of a computer software program configured to calculate insurance modification factors for use in assessing the risks associated with issuing patent infringement and validity insurance policies.

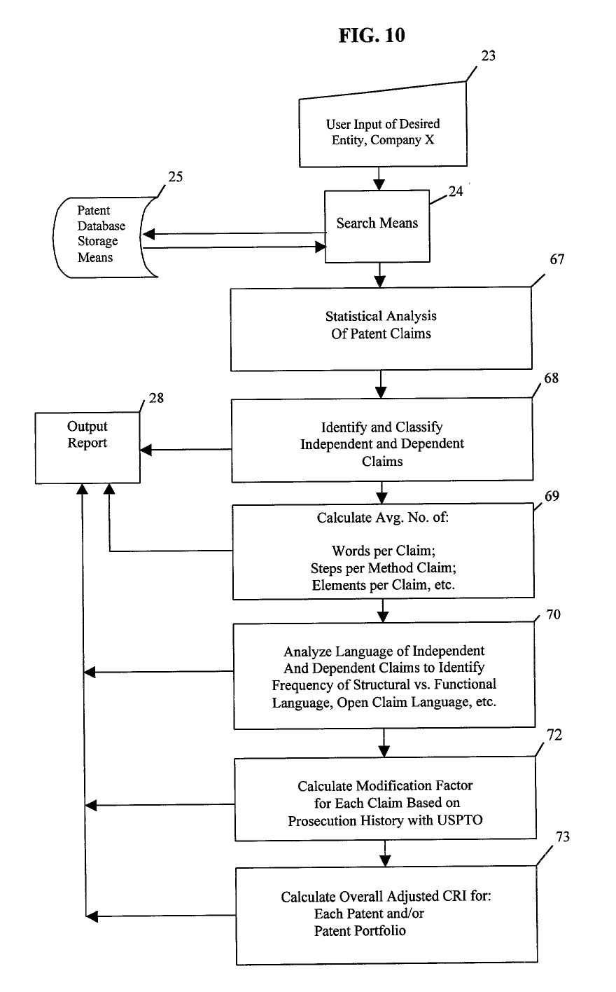

FIG. 10—A block diagram of the arithmetic logic circuit of a computer software program configured to perform patent Claim strength analysis and determine CRI factors.

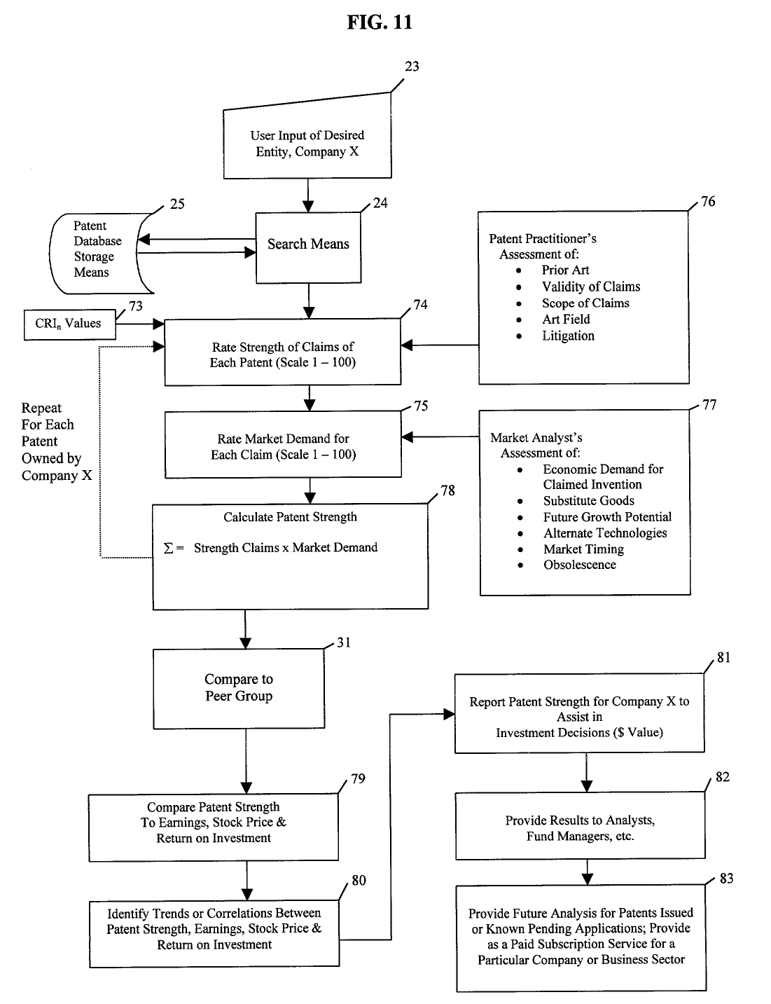

FIG. 11—A block diagram of the arithmetic logic circuit of a computer software program configured to calculate the Patent Strength of a given patent based on an analysis of the strength of the patent claims and market analysis of the commercial value of the patent claims, store results, and perform comparative analysis.

### DETAILED DESCRIPTION

Definitions:

Average Patent Term—An output factor generated by the present invention. The Average Patent Term is generated by summing the number of years remaining on the patent term for each enforceable patent owned by a company (assuming all requisite maintenance fees are paid). The sum is then divided by the total number of enforceable patents owned by such company to arrive at a value known as the Average Patent Term, as demonstrated by the following equation:

$$Average Patent Term = \frac{\begin{matrix}\sum Years remaining on patent terms \\ for all enforceable patents\end{matrix}}{\begin{matrix}Number of enforceable patents \\ owned by company\end{matrix}}$$

Claim Ratio Index (CRI)—An output factor generated by the present invention. The CRI is a measure of the average number of words per dependent claim, independent claim, or both, in a patent or patent portfolio. This may be represented (for independent claims) by the following equation:

$$C R {I}_{i n d e p e n d e n t c l a i m s} = \frac{\sum ( Number of words in all independent claims )}{Total number of independent claims}$$

The CRI may be adjusted based on an analysis of the use of functional limitations as well as prosecution history and other factors to assess the strength of patent claims in an automated fashion.

Company—Includes, but is not limited to, at least the following: companies including any and all subsidiaries, affiliates or other entities under common control or management; partnerships of any type; corporations of any type; international corporations and partnerships of any type; limited liability companies; any organization organized under the laws of any nation, state, or province; governmental agencies of any type; mutual funds companies of any type; stock clubs; and any other grouping of individuals or entities.

Future Patent Power—An output factor generated by the present invention. The Future Patent Power is a measure of the future power of a company's patent, or patent portfolio over time and can be generated by plotting Patent Years as a function of time. The Patent Years factor is plotted on the y axis and time is plotted on the x axis to generate a line. The area beneath such line is defined as Future Patent Power and can be calculated using standard mathematical principals well known to those of ordinary skill in the art, such as integration and numerical analysis methods.

Individual—Any individual or entity in need of information on the assessment of intellectual property valuations for any reason whatsoever.

Intellectual Property—Includes, but is not limited to, at least the following: U.S. utility patents, U.S. plant patents, U.S. reissue patents, U.S. reexamination patents, pending U.S. patent applications (including divisionals, continuations, continuations in part, continuing applications, continuing examination applications, requested continued examination applications), international patents of any type, pending foreign applications of any type, design patents, industrial designs, trademarks, servicemarks, intent to use trademarks, mask works, copyrights, pending trademark applications, licenses, patent licenses, cross licenses or pooled patent licenses, trade secrets, know how, showhow, domain names, confidential materials owned by a company not publicly known, and any other aspect of intellectual property that gives a company a competitive edge, or otherwise enhances the value of a company.

Patent Strength—An output factor generated by the present invention. Patent Strength is a measure of the overall strength of a patent or patent portfolio and can be determined by evaluating the strength of each patent claim, on a scale of 1 through 100, or similar scale, wherein the higher the value, the greater the patent strength. The strength of each patent claim is determined by an automated claim analysis method as taught by the present invention and/or a patent practitioner's professional assessment of a number of factors, such as the state of the prior art, anticipated validity of the claim, scope of the claim, pending litigation, and other factors which tend to increase or decrease the relative strength of a particular patent such as Overall Adjusted Claim Ratio Index, Claim Ratio Index, Future Patent Power, Patent Years, Average Patent Term, percentage of lapsed patents in a company's patent portfolio, percentage of patent applications pending in a company's patent portfolio, percentage of patents that have been invalidated in a company's patent portfolio, percentage of patents in a company's patent portfolio that have been involved in litigation and claim scope. The market demand for each patent claim is also determined on a scale of 1-100, or similar scale, wherein the higher the value, the greater the market demand. The market demand of each patent claim is determined by a market analyst's professional economic assessment of a number of factors, such as demand for the claimed invention, present market share controlled by the patent owner or licensee, marketing channels, future growth potential, alternate or substitute goods or technologies for the claimed invention, obsolescence and market timing, as well as other factors which tend to increase or decrease market demand for the claimed invention. Patent Strength is then calculated as the summation of the product of market strength times Claim strength for each claim in a patent or patent portfolio.

Patent Years—An output factor generated by the present invention. The Patent Years for a particular patent is equal to the sum of the number of years remaining on the patent term for each enforceable patent owned by a company.

The present invention is for a system, method and computer program product for assessing the valuation of the intellectual property of companies. The invention provides for a way to assess the valuation of a company in a manner that avoids the distorting effects of news reports, litigation, market trends, speculation, company press releases, governmental reports, the ever dangerous rumor, and the like. These communications often times cause stock prices to fluctuate wildly, often times due to reasons that are in no way related to the financial health or true value of the company.

The system and methodology of the present invention reduces and/or avoids these problems. Further, the present invention is especially useful at times when the stock market is experiencing volatility, because brokerage houses, mutual funds, individuals, etc. can look to the assessment report generated by the present invention and remain confident that the company being analyzed still has the stable worth of the assessed valuation of its intellectual property portfolio. The value of the intellectual property is then factored with the other known assets, liabilities and information of the company to provide an accurate determination of the company's true value.

Turning now to FIG. 1, shown therein is a flowchart depicting the architecture for the computer software program product for the present invention. It is noted that the following sequential operations illustrated in the flow chart may be carried out by hand, but such a process would be excessively time consuming, tedious, complex, inefficient, and unable to instantaneously provide intellectual property assessment reports on demand. Therefore, the invention is described as being embodied in a computer program which is used to efficiently and expediently generate the output factors described herein. To assist in the use of the present invention, such computer program would operate on or be executed on a personal computer, client server system or mainframe computer, and could easily be made accessible to users via modem connection, the internet (using wired or wireless technologies), or other data processing and computational techniques known to those of ordinary skill in the art.

FIG. 1 is a flow chart which shows the sequencing of the steps in the computer program of the present invention. Initially, before the output report 28 is accessible to the user, various data is input 1 into the computer. FIG. 1 shows that the company name to be assessed is first input, which may be a mutual fund, for example, or even an individual investor interested in assessing his or her own portfolio.

Next, company specifics 2 are input, such as the name of the company, number of employees, number of shares, stock price, dividends, stock splits, directors, officers, headquarters, etc. The inputs may be varied for different companies and individuals. They can be tailored to each specific company, as per the user's request. Users include, but are not limited to, stock analysts, consultants, brokerage houses, mutual funds or any other individual or entity interested in the output report generated by the computer program.

The next step 3 is to enter data pertaining to the specific intellectual property portfolio of the company. The portfolio may include at least the following: U.S. nonprovisional utility patents; U.S. reissue patents; U.S. provisional patents; pending U.S. patent applications (including divisionals, continuations, continuations in part, continuing applications, continuing examination applications, requested continued examination applications); international patents of any type; foreign applications of any type; design patents; industrial designs; trademarks; intent to use trademarks; mask works; copyrights; trade secrets; domain names; confidential materials owned by the company not publicly known plus any other aspect of intellectual property that gives a company a competitive edge, or otherwise enhances the value of a company, as defined previously.

A computer/data processor 4 is provided, which generates data structures. These data structures store and organize all of the information pertaining to a particular company, using procedures well known to those of ordinary skill in the art. All the information is thus stored in a large database in an organized format, in a manner known to those of ordinary skill in the art.

The next step calls for the use of a report generator 5 for the generation of a professional assessment report (hereinafter “report”, “output report” or “report record”) 28. At this point, automated techniques as further described and taught by the present invention and/or skilled professionals in the arts of intellectual property use their expertise to create a report, utilizing the data stored in the database to prepare the report. Patent practitioners, attorneys, market advisors, business analysts, and others with relevant expertise may be the skilled professionals assessing the intellectual property holdings of the company. For example, if the valuation of a large company came into question, the methodology described herein could be used to quickly generate a detailed and reliable report. The skilled professionals would consider all the intellectual property of the company and generate a output report 28 having the professional assessment and valuation findings and opinions, including both current and future intellectual property valuations. To date, no such adequate service and methodology exists.

Additionally, once the output report 28 is generated, the report may be mailed 8, stored to a disk 9, or accessed on-line by authorized users 7. For example, if a brokerage house 10 ordered the report 28, it could view the output report on-line, or over the world wide web. Of course, this information would be protected with state of the art security systems, such as encryption techniques, well known to those of ordinary skill in the art.

The brokerage house or market analyst 10 then combines the data contained in the output report 28 with the other known assets, liabilities and other information 11 of a company to issue a recommendation 12 to investors to buy, sell or hold the stocks and bonds of a given company. A useful aspect of the present invention is that the output report 28 also includes an accurate assessment of the future value of the intellectual property portfolio instead of just a present value. This is useful for providing investment advice on companies where an investor wishes to buy a stock or other security when the current price is low but the future value of the company's intellectual property is high.

Thus, the present invention allows a brokerage house, mutual fund or other advisor to make a well-reasoned, intelligent decision before investing large sums of monies in a company. Additionally, in times of market turmoil, a brokerage house or mutual fund may look to the output report for assurances that the companies they own are backed by solid intellectual property. Further yet, mutual fund managers and brokers who utilize the output report generated by the system and methodology in their decisions on buying and selling stocks will have advanced their fiduciary duty of care to their shareholders and clients.

The present invention is also useful in the valuation of certain companies interested in obtaining venture capital from potential investors. For instance a small privately held company, perhaps interested in issuing an initial public offering (commonly known as an IPO) might use the present invention to prepare a detailed report on the nature of its intellectual property holdings. This report can then be shared with potential investors to demonstrate the company's relative strengths in particular fields of technology, especially when comparative analyses are performed against the intellectual property portfolios of a representative peer group comprised of competitors or potential competitors.

In one embodiment, the invention comprises a computerized data processing system, method and computer software program product for calculating and evaluating the scope and content of the patents owned by a company. The data processing system and computer software allow a user to evaluate the patents owned by a company and to perform a variety of statistical analyses on the company's patent portfolio. One feature of the software permits a user to analyze the remaining term of each respective patent owned by a company, and aggregates through a summation technique the cumulative years remaining in the company's patent portfolio, which is then represented as a numerical result. Similar calculations may then be performed on the patent portfolios of entities that compete in the market place with the company being assessed. These numerical results may then be compared to determine the relative size and value of the patent holdings of each company.

FIG. 2 depicts a block diagram that demonstrates the general operative relationship of the computerized data processing system and computer software for assessing a company's intellectual property portfolio. For the purposes of the following embodiment, an analysis of the patents owned by a company is described. However, the analysis may also be performed to assess trademarks, copyrights, licenses, and so forth. The block elements of FIG. 2 represent the discrete elements of a computer processor and electronic storage means, such as a personal computer, server or mainframe computer. An initialization means 20 initially prepares the computer software and related data storage media to perform the calculations and initialize the data storage media. The initialization means 20 is in the form of an arithmetic logic circuit configured and arranged to prepare the data storage media to magnetically store selected data. This step clears storage registers to permit subsequent computerized calculations to be performed and the results thereof to be stored.

A display means 21 provides a display that informs the user of the computer software with a variety of selections pertaining to the use of the computer software. The display means 21 is preferably a cathode ray tube or liquid crystal display (“LCD”) configured and arranged so that a graphical user interface, hereinafter a GUI, may be displayed on the screen display. After reviewing the various selections, the user uses an input data means 23, such as a computer keyboard or mouse, to select a particular option for calculation and inputs the data to the initial processing means 22. Along with selecting an option, the user also inputs data pertaining to the company that is being analyzed, such as the corporate name and other corporate details.

The initial processing means 22 is an arithmetic logic circuit configured to receive and prepare the input data for further analysis by the computer processor means 40. The initial processing means 22 feeds output data in a usable form to a database search means 24. The database search means 24 is an arithmetic logic circuit configured to transmit data to a computerized patent database storage means 25 containing computerized records of issued patents and pending patent applications. The patent database storage means 25 is a computer database containing extensive records of issued patents and pending patent applications. This database includes information such as the date a particular patent application was filed, the date the patent issued, the inventors of the patent, the assignee (owner) of the patent, the classification assigned to the patent by the U.S. Patent and Trademark Office or other similar agencies of foreign countries, the references cited by the patent examiner, the patents that cite a particular patent and other pertinent information, including all information contained in the patent. Patent databases are well known in the art, and one readily accessible database is supported by the United States Patent and Trademark Office (“USPTO”) and is available over the Internet at the domain name address www.uspto.gov. While the USPTO is referred to throughout this embodiment, it should be apparent that other databases, some of which contain details of patents issued by foreign jurisdictions, are readily available and are encompassed by the present invention. Further, in other embodiments of the present invention, the databases may contain information on trademarks, copyrights, industrial designs, international patents and so forth.

The patent database storage means 25 returns requested information regarding the patents owned by a particular company as well as other pertinent information requested by the user. The information returned by the patent database storage means 25 is then analyzed, calculated and assessed by computer processor means 40. The computer processor means 40 could be a personal computer, server, mainframe computer, or other computer device well known to those of ordinary skill in the art, and contains an arithmetic logic circuit configured to retrieve information from a file, perform calculations and generate an output report 28.

The user is then provided with an opportunity 27 to perform a peer group analysis 31, as shown in FIG. 2. If the user elects not to do so, an output report 28 is generated containing statistical details as well as analyses conducted on the patent portfolio owned by a company. This output report 28 may be displayed to display means 30, such as a computer monitor or other known display device, or the output report 28 may be stored to a storage means 29, such as a data disk or compact disk capable of magnetically storing the output report 28. The output report 28 can also be printed in hard copy format on paper media for further review, analysis or other use or transmitted to an authorized user by carrier wave propagations.

If the user elects to perform a peer group analysis 31, a peer group input means 32 is used to input information regarding the members of the peer group of the company under consideration. A peer group analysis 31 similar to the one described above is performed for each peer group member and the output report for each peer group member is provided and may be compared to the output report for the company under consideration. The members of the peer group are typically competitors of the company under consideration, and the present invention provides a convenient and useful tool for evaluating the patent portfolios of each company on a generally equivalent basis to assist in investment decision making. An output report 28 is then generated from the peer group analysis 31 and transmitted to the user to display means 30 or storage means 29. Again, the output report 28 can also be printed in hard copy format on paper media for further review, analysis or other use.

Similarly, a user may also elect to proceed to the sensitivity analysis means 34 or the competitive analysis means 37. The sensitivity analysis means 34 is an arithmetic logic circuit configured to use input information, perform calculations and generate an output report 28 based on the sensitivity of patent portfolio data to relative changes in the input data. The input to this analysis 35 is received and includes information on pending patent applications, patents that have been invalidated by a court, or patents that are currently subject to litigation. Another output report 28 is generated containing statistical details on the sensitivity of the patent portfolio owned by a company to change. As before, this output report 28 may be displayed to a computer display 30, be stored to on storage means 29, or transmitted to an authorized user by carrier wave propagations. The output report 28 can also be printed in hard copy format on paper media for further review, analysis or other use.

Likewise, a user may also elect to proceed to the competitive analysis means 37. The competitive analysis means 37 is an arithmetic logic circuit configured to use input information, perform calculations and generate an output report 28 based on the external market conditions affecting the strength of a particular patent when compared to the strength of the claims of a patent. The input to this analysis is received from market data input means 38 that contains information on expected market trends, current demands in the marketplace for goods covered by a patent and markets for substitute goods. Another output report 28 is generated that describes the overall strength of the patent portfolio owned by a company. As before, this output report 28 may be displayed to a computer display 30, or be stored to storage means 29, or transmitted to an authorized user by way of a carrier wave propagation. The output report 28 can also be printed in hard copy format on paper media for further review, analysis or other use.

FIG. 3 depicts a diagram representing the general relationships of the database means, computing means and storage means for the data processing system, in the present system and methodology for assessing the intellectual property portfolio of a company. Patent database storage and organization means 25 contains detailed information about patents and pending patents, including but not limited to, filing date of patent applications, issue dates, inventors, assignees, classification of the patents, references cited by the patent examiner during the prosecution of the patent applications, full text of all patents, as well as data for pending patent applications. Computer processor means 40 is arranged in operative relationship to patent database storage means 25. Computer processor means 40 represents a computer and associated software for executing a computer executable program and for performing data processing operations and analysis on data received from patent database storage means 25. The patent database storage means 25 may also be embodied as a trademark database storage means, or other intellectual property database storage means.

FIG. 3 further shows computer processor means 40 arranged in operative relationship to company data input means 42, peer group data input means 32 and market data information input means 38. As instructed by the user, computer processor means 40 performs data processing operations and analysis on data input from means 42, 32 and 38. Company data input means 42 includes detailed information about the company that is the subject of the intellectual property assessment, such as the market capitalization of a company, annual sales, debt/equity ratio, earnings per share, assets, liabilities, product sales, research and development expenditures, pending litigation, etc.

Peer group data input means 32 may include detailed information about the members of the peer group (ex. competitors) of the company that is the subject of the intellectual property assessment, such as the identities of competitors of the company under evaluation, market capitalization of the peer group, annual sales, debt/equity ratio, earnings per share, assets, liabilities, product sales, research and development expenditures, pending litigation, etc.

Market data input means 38 may include detailed information about the market, or market sector occupied by the company that is the subject of the intellectual property assessment, such as consumer demand in a particular market segment, expected growth in a segment, market alternatives, etc. Input means 25, 42, 32 and 38 each represent information input manually, via input files or via access to databases where information is magnetically stored in electronic format in data registers on a data disk. The information may also be stored in optical disks, CD-ROMs, and carrier wave propagations.

As shown in FIG. 3, computer processor means 40 is also arranged in operative relationship to market analysts 41 and storage means 29. The detailed intellectual property assessment reports 28 generated by computer processor means 40 are delivered to users (ex. analysts) 41 via storage means 29, or via a direct link to the computer processor means 40 by way of the internet and the worldwide web, by carrier wave propagations/transmissions, or other means known to those of ordinary skill in the art. In this fashion, by using the computer and software represented by computer processor means 40, analysts are able to obtain up-to-date detailed information about the patent portfolio of a company in real time. In the alternative, software embodying the present invention may be provided to such market analysts pursuant to a software license for use on the personal computers of such market analysts. Such users 41 comprise mutual fund managers, underwriters for the issuance of securities, venture capitalists, brokerage houses, sophisticated investors and industrial strategists interested in performing evaluations of the competition in a particular market sector, or across different sectors.

As stated earlier, the output report 28 may be used for purposes of comparative analysis of companies in a particular industry sector. In the alternative, the output report 28 may also be utilized to compare different industry segments for purposes of identifying potential investment opportunities, sales opportunities or otherwise. For instance, a user may use the output report to assess differences in the intellectual property holdings of the fiber optic sector of the market as opposed to the biotechnology sector, and may use the results of such comparison to assist in investment decisions. The output report 28 may also be of use to assess discernable changes in the number of patents issued and/or patents pending in market sectors to predict future shifts in market trends, and to identify investment opportunities before the market as a whole identifies such investment opportunities.

FIGS. 4 through 11 are flowcharts that depict various analysis techniques, any of which may be performed by computer processor means 40, to evaluate a company's patent portfolio. In particular, FIG. 4 depicts a block diagram of the arithmetic logic circuit of a computer software program and processor 40 configured and arranged to calculate the average patent term remaining on the patents owned by a company. The first step involves the user inputting the name of a particular entity, say Company X, which the user desires to evaluate. An arithmetic logic circuit 24 configured to perform database searches and retrieve data pertaining to such search, then searches and retrieves the required data from patent database storage means 25. In this instance, information is retrieved on the filing and issue dates for all patents owned by Company X. This information is then transferred to arithmetic logic circuit 50 configured to perform calculations on the average remaining term of the patent portfolio of Company X. Arithmetic logic circuit 50 performs a summation calculation of the number of years remaining on the patent term for each enforceable patent owned by Company X prior to the expiration of each patent (assuming all requisite maintenance fees are paid). The summation is then divided by the total number of enforceable patents owned by Company X to calculate the average term remaining for the patents in Company X's patent portfolio, as demonstrated by the following equation:

$$Average Term = \frac{\begin{matrix}\sum Years remaining on patent term for \\ all patents owned by Co . X\end{matrix}}{\begin{matrix}Number of enforceable \\ patents owned by Co . X\end{matrix}}$$

This information is then output and stored in output report 28, and if desired, the user may then perform peer group analyses by reperforming the above calculations on the patent portfolios of competitors to compare the average term of Company X's patent holdings against that of its competitors. Other comparisons may also be performed by analysis means 37. This might involve comparing Average Term against research and development expenditures by Company X over various periods of time.

The information generated by this software is useful to a variety of users. For instance, a fairly mature company, named Company Y, might hold twenty patents, with an average remaining term of only four years per patent. A competitive company, named Company Z, with a more recently issued patent portfolio might hold only fifteen patents but with an average remaining term of sixteen years. For investment purposes, an analyst may use this information to assess a higher value to Company Z's patent portfolio, as compared to the mature Company Y. The analyst may further use this information and conclude Company Z is a more prudent investment than Company Y over the long term due to the fact that Company Z has more years remaining in its patent portfolio than Company Y.

The computer software and data processing system of the present invention may also be used to process and generate output data that is useful to market analysts. For instance, FIG. 5 depicts a block diagram of the arithmetic logic circuit of a computer software program and processor 40 configured and arranged to calculate useful portfolio assessment factors deemed “Patent Years” and “Future Patent Power”. The first step is similar to the initial step shown in FIG. 4 and involves an arithmetic logic circuit 24 which searches and retrieves the required data from patent database storage means 25. In this instance, information is retrieved on the filing and issue dates for all patents owned by a company named Company X. This information is then transferred to arithmetic logic circuit 51 configured to perform calculations on the remaining term of each patent contained in the patent portfolio of Company X. Arithmetic logic circuit 52 performs a summation calculation of the number of years remaining on the patent term of each enforceable patent owned by Company X. The raw value of the summation is then output as a result and is denominated as the “Patent Years” for Company X. The Patent Years of Company X may then be compared to the Patent Years of other companies. The Patent Years factor may be represented as follows:

$$Patent Years = {\sum }_{i = 1}^{k} ( Years remaining on term of {patent}_{i} )$$

where k=the total number of patents being assessed in a company's patent portfolio; and

where i is a counter for counting the number of patents.

For example, assume Company X owns two patents, each having ten years remaining on each respective patent term before expiration. The Patent Years for the Company X portfolio would equal 20 (2 (number of patents)×10 (number of years remaining before each patent expires) equals 20 Patent Years). Now assume another company, named Company Y, owns twenty patents, each patent having only one year remaining on each respective patent term. Company Y would also have a portfolio equal to 20 Patent Years (20 (number of patents)×1 (number of years remaining before each patent expires)). Thus, as a general statement, the gross size of each company's patent portfolio, measured in Patent Years, is equal, that is both Company X and Company Y each have a portfolio equal to 20 Patent Years.

To assist in evaluation of the future value of a patent portfolio, an additional computational step may be employed. As shown in FIG. 5, a plot may be developed where the Patent Years factor is plotted as a function of time. In the plot shown, Patent Years are plotted on the y axis and time is plotted on the x axis to generate a graph. The graph demonstrates that after a given period of time, all of the patents in a given portfolio will expire, leading to a zero value for Patent Years at some future date. A simple mathematical formula represents this relationship and standard mathematical formulae may be employed to calculate the area under the line shown in FIG. 5. This area is referred to as “Future Patent Power”, and is a number that represents the total future time value of a given company's patent portfolio. Arithmetic logic circuit 53 is configured to perform plotting and/or area calculations on the Patent Years contained in the patent portfolio of Company X plotted against time. Arithmetic logic circuit 53 then performs an integration calculation to calculate the area under the representative line and hence arrive at a value for Future Patent Power.

This information is then output and stored via output report 28, and if desired, the user may then perform peer group analyses to compare the Future Patent Power of Company X's patent holdings against that of its competitors. Other comparisons may also be performed by comparison means 37.

Again, the information generated by this software is useful to market analysts. For instance, returning to the Patent Years example provided above, assume Company X owns two patents, each having ten years remaining on each respective patent term. The number of Patent Years is equal to 20 (2 patents times 10 years). Future Patent Power may now be generated as follows. The y axis represent Patent Years and has a value of 20 at time equals zero, and the x axis represents time in years. After 10 years, there is no time remaining on either of the patent terms, and thus at time equals ten years, the Patent Years value is zero, as show in FIG. 5. In this example, the relationship of Patent Years with respect to time is linear in nature, and may be represented by the formula

y=mx+b,

where m is the slope of the line and b is the y axis intercept. They intercept, in this example, is 20 at time zero (present time). The slope of this line is negative 2. The Future Patent Power for Company X's portfolio would equal 100 (area=½ base×height of the triangle formed by the line and the respective axes, where the base=10 and the height=20)). The same result may be achieved by integrating the equation for the line y=mx+b, and finding the area under the line using mathematical techniques well known to those of ordinary skill in the art. The line generated by plotting Patent Years versus time may be linear or nonlinear (i.e. a curved line) depending on the characteristics of the patent portfolio under consideration.

Now, assume Company Y owns twenty patents, each having only one year remaining on each respective patent term. Using the technique described above, Company Y would have a Future Patent Power of only 10. Hence, the Future Patent Power of Company X is ten times greater than that of Company Y, and thus might make Company X a more attractive investment based on the greater future value of its intellectual property.

In addition, changes to Future Patent Power over time may be plotted and rates of change with respect to time can be generated by the present invention, as shown in FIG. 5. Arithmetic logic circuits 53 and 54 are configured to perform plotting and rate of change calculations 55 on Future Patent Power. Decreases in Future Patent Power over time are indicative of a company that is losing strength in its patent portfolio, whereas increases in Future Patent Power are indicative of a company that is gaining strength in its patent portfolio. This analysis is more meaningful than a simple annual comparison of the number of enforceable patents owned by a company because the present invention evaluates the relative value of each patent and its remaining term in a single representative numeric value. Similar peer group comparisons may be performed.

The computer software and data processing system of the present invention may also be used to process and generate other data of use to market analysts. For instance, FIG. 6 depicts a block diagram of the arithmetic logic circuit of a computer software program and processor 40 configured and arranged to calculate a variety of useful information pertaining to the patent portfolio of a company. The first step is similar to the initial step shown in FIG. 4 and involves an arithmetic logic circuit 24 which searches and retrieves the required data from patent database storage means 25. In this instance, information is retrieved on the number of active patents in a company's portfolio, the number of lapsed patents in a portfolio for failure to pay statutory maintenance fees, the number of pending patents (to the extent publicly known), and information on lawsuits and invalidated patents. This information is then transferred to arithmetic logic circuit 56 configured to perform calculations on the percentage of lapsed patents in a company's portfolio (that otherwise would have been in force). This information is useful because it may then be compared to peer group information to determine the relative commercial usefulness of a company's patent portfolio. If a company has a high patent lapse percentage, the value of its remaining patents may be of questionable commercial value.

Information is also transferred to arithmetic logic circuit 57 configured to perform calculations on the percentage of patents pending in a company's portfolio divided by the total number of enforceable patents owned by a company. This information is useful because it may then be compared to peer group information 31 to determine the relative expected growth of a company's patent portfolio with respect to its peers. In addition, the number is useful for assessing overall stability of a patent portfolio. Higher ratios would appear better than lower ratios.

Information is also transferred to arithmetic logic circuits 58, 59 configured to perform calculations on the percentage of patents in a company's portfolio that were invalidated or are involved in lawsuits when divided by the total number of enforceable patents owned by the company. This information is useful because it may then be compared to peer group information 31. A high invalidity ratio compared to a peer's ratio indicates a somewhat weaker patent portfolio.

The computer software and data processing system of the present invention may also be used to process and generate yet other data of importance to market analysts. For instance, FIG. 7 depicts a block diagram of the arithmetic logic circuit of a computer software program and processor 40 configured and arranged to calculate a variety of other useful information pertaining to the patent portfolio of a company. The first step is similar to the initial step shown in FIG. 4 and involves an arithmetic logic circuit 24 which searches and retrieves the required data from patent database storage means 25. In this instance, information is retrieved on the inventors and class designations of the enforceable patents in a company's portfolio. This information is then transferred to arithmetic logic circuit 60 configured to perform calculations on the percentage of the patent portfolio that was invented by each inventor. If a high percentage of patents was developed by a particular inventor, the company may be somewhat susceptible to personnel changes. For instance, if a particular inventor was named as an inventor to more than a threshold percentage of the patent portfolio (say 10 percent), the company is sensitive to a change in personnel, with a weaker patent position. This information is useful because it may then be compared to peer group information to determine the relative sensitivity of a particular company to changes in personnel. In addition, an arithmetic logic circuit 62 may be provided in the software to list all the inventors named on patents owned by a company, along with the number of patents awarded to each inventor. This information is particularly useful for identifying key personnel, the loss of which is harmful to a company and potentially beneficial to competitors. It is also useful for a company interested in acquiring or soliciting key personnel from a competitor. For instance, assume output report 28 identifies several prolific inventors, each having invented and assigned a significant number of patented inventions to Company X. These individuals are presumably employed by Company X. Company Y, a competitor of Company X, may review the output report 28, identify the prolific inventors, and then attempt to hire these inventors away from Company X in order to improve its own technical staff, and to increase the value of the intellectual property of Company Y.

Output report 28 is also useful for determining changes in key personnel. The loss or acquisition of key inventors by an organization may be viewed as a leading indicator of the potential future strength or weakness of the organization's intellectual property portfolio. For instance, assume output report 28 identifies several prolific inventors, each having invented and assigned a significant number of patented inventions to Company X. Again, these individuals are presumably employed by Company X. At a later time, output report 28 now identifies one or more of such prolific inventors having assigned patented inventions to Company Y. It may be assumed that these individuals are now employed by Company Y. Such a change in personnel may be viewed as an indicator of potential changes to the future patent portfolios of Companies X and Y, and hence may be an indicator of changes to the future market value of such companies.

Similarly, arithmetic logic circuit 64 may be provided in the software to determine the identities of the companies holding patents in a particular patent classification. This information is useful to assess the amount of patent control exerted by a particular company in a given market sector. In addition, the relative strength of a company's patent portfolio may be assessed by performing a comparison 63 of the number of patents held by the company in a particular patent classification with the number of patents held by its competition in the same or similar patent classifications.

FIG. 8 depicts a block diagram of the arithmetic logic circuit of a computer software program and processor 40 configured and arranged to perform comparisons of the output with other known corporate data. For instance, Patent Years may be plotted against past time, and compared to research and development expenditures, stock price, earnings and other known corporate data over time to assess correlations and sensitivity of a company to changes in its patent portfolio holdings.

Another aspect of the present invention involves application to the insurance industry. FIG. 9 is a flow chart depicting the use of the present invention in an insurance context. Many insurance companies presently offer insurance policies that cover claims of patent infringement by third parties based on the business activities of the insured. Such companies also offer patent validity insurance that provides coverage for risks associated with the acquisition of patents in commercial transactions, as well as other intellectual property insurance policies for trademark infringement, etc. Patent infringement insurance generally operates as follows. Company A (the “Insured”) 96 purchases patent infringement insurance from an insurance company (the “Insurer”) 90 by payment of a premium 97. This insurance is typically for a certain amount of coverage (ex. $10 million in coverage), and is typically governed by an insurance policy that contains many terms and conditions, such as covered losses, deductibles, notice requirements, subrogation rights, etc. In the event a third party claims that the acts of the Insured 96 constitute infringement of a patent owned or licensed by such third party, the Insured 96 places the Insurer 90 on notice of such claim. By the terms of the insurance policy, the Insurer 90 generally has the duty to indemnify, defend and hold the Insured 96 harmless from such claims. The cost of such indemnification and defense may ultimately prove to be very high depending on the particular facts of the case. Hence, it would be financially prudent for an Insurer 90 to fully understand the risks involved with issuing a particular patent infringement insurance policy prior to such issuance.

Similarly, patent validity insurance is a useful risk allocation device in the context of the sale of a patent from a first party (the “Seller”) to a second party (the “Buyer”). Such sales may arise in the context of the direct sale of a patent, or in the context of a corporate acquisition. Patent validity insurance generally operates as follows. The Buyer (or the Seller) purchases patent validity insurance from an insurance company (the “Insurer”). This insurance is typically for a certain amount of coverage (ex. $10 million in coverage), and is governed by an insurance policy as discussed earlier. In the event the Buyer attempts to enforce a recently acquired patent against a third party, such third party may claim as a defense that the asserted patent is invalid, and attempt to have a court invalidate such patent. In the alternate, a third party may seek to have a patent declared invalid by way of a judicial action seeking a declaratory judgment of invalidity. There are numerous grounds for seeking invalidity, such as prior art, inequitable conduct before the USPTO, etc. In the event a third party claims that a patent owned by the Buyer is invalid, the Buyer places the Insurer on notice of such claim. By the terms of the insurance policy, the Insurer generally has the duty to indemnify, defend and hold the Buyer harmless from such claims. The cost of such defense and indemnification, again, may be quite high and could expose the Insurer to great financial risk depending on the particular facts of the case. Again, it would be financially prudent for an Insurer to fully understand the risks involved with issuing a particular patent validity insurance policy prior to such issuance.

The present invention includes a method of generating and applying a risk assessment modification factor (“Mod Factor”) 91 for use by an Insurer 90 prior to issuing a patent infringement or patent validity insurance policy. The software of the present invention can be used to determine the companies holding patents in a particular classification. This information can then be compared against the line of business that the Insured 96 seeks to have insured under a patent infringement policy. If the software indicates a high concentration of potentially competing patents in a particular classification, or if the invention or business activities of the Insured 96 falls in a classification or market segment with litigious competitors, then, as compared to a statistical average, issuing a patent infringement or validity policy to the Insured would present a greater than average risk to the Insurer 90. The Insurer 90, based on the results, can develop a Mod Factor 91 that indicates the level of risk associated with issuing such a policy. The Mod Factor will be used in a risk assessment analysis 92 to determine whether the Insurer 90 should either decline to issue such a policy and refuse coverage 93 or in the alternate, modify (i.e. increase or decrease) the premium cost 94 to the Insured 96 and issue the requested patent infringement policy 95. The Insured 96 then pays the required premium 97, and the patent infringement insurance policy is then in place. Similarly, the software of the present invention may be used to determine the number of patents, Average Patent Term, Patent Years, Future Patent Power and Patent Strength for the competitors of the Insured 96. Again, these factors can be used to adjust the Mod Factor 91 accordingly. For instance, in the event a competitor of the Insured 96 has a patent portfolio with a statistically higher Average Patent Term, the Mod Factor 91 would be increased, since this represents a greater risk of a claim of patent infringement against the Insured 96 during the course of the future. A similar Mod Factor 91 may be developed for use in issuing patent validity insurance.

The Mod Factor 91 may be generated using the following equation:

Mod Factor=Σα₁(Average Patent Term)+α₂(Future Patent Power)+ . . . αₙ(IX)

where α₁, α₂ . . . αₙ are various weighting coefficients determined by the type of industry, level of technology, business activities of the Insured 96, or other factors deemed pertinent by the Insurer 90. X represents the particular patent factors utilized in the analysis, and may include factors in addition to Patent Years, Future Patent Power and Average Patent Term. For instance, the number of patents issued per year to a competitor may be of use, as well as the percentage of previous patents of the Insured 96 that have been held invalid in the past. Also, the statistical makeup of the inventors may be of use in determining the Mod Factor 91. In this fashion, the present invention is useful for determining levels of risk associated with the issuance of patent infringement insurance and patent validity insurance policies, and provides the Insurer 90 with a methodology for minimizing such level of risk through the adjustment of insurance premiums, or the refusal to issue insurance coverage.

FIG. 10 depicts a block diagram of the arithmetic logic circuit of a computer software program and processor 40 configured to calculate a useful patent factor designated as the Claim Ratio Index (the “CRI”). The CRI may be generated for each claim of a patent, for each patent in a company's portfolio, and/or for a company's patent portfolio as a whole. The CRI is calculated as follows. The first step involves a user inputting certain information pertaining to a patent that the user desires to analyze. Arithmetic logic circuit 24 performs a search and retrieves the required data from patent database storage means 25. In this instance, the information retrieved is the text of the claims of selected, or all, patents in a company's patent portfolio. This information is then transferred to arithmetic logic circuit 67 which is configured to perform a statistical analysis of the claim language of each patent being analyzed. An analysis may be performed on a single claim, all claims in a patent, the independent claims in a patent, the dependent claims in a patent, all of the claims in a company's patent portfolio, or any combination thereof.

For each patent being analyzed, arithmetic logic circuit 68 sorts and classifies the patent claims as either independent or dependent claims. This may be done using a technique that identifies the character of independent claims as distinct from dependent claims, through the use of alphanumeric recognition techniques well known to those of ordinary skill in the art. For instance, should a claim contain a phrase such as “the apparatus set forth in claim 1 further comprising . . . ”, it would be identified as a dependent claim.

Arithmetic logic circuit 69 then performs a variety of calculations for each independent and dependent claim. The number of words in each independent claim is determined, summed and then divided by the total number of independent claims in the patent to arrive at a number representing the average number of words per independent claim, generally referred to as the Claim Ratio Index. This calculation may be represented by the following equation, for either a single patent or a number patents in a company's patent portfolio:

$$C R {I}_{i n d e p e n d e n t c l a i m s} = \frac{\sum ( Number of words in all independent claims )}{Total number of independent claims}$$

As a general principle, the addition of words to a patent claim generally tends to decrease the scope of such a claim, in that the additional words are often limitations that decrease the likelihood of broad exclusionary patent rights. Hence, as a general principle, independent claims with fewer words typically provide the patent owner with broader coverage than independent claims with a greater number of words. Hence, patents with low CRI values correspond generally to patents with broader scope, and potentially greater commercial value, whereas patents with high CRI values correspond to patents with narrower scope, and potentially lesser commercial value. A similar calculation may be performed for all of the dependent claims in a patent as well, with lower CRI values corresponding to broader patent coverage, and higher CRI values corresponding to narrower patent coverage. A similar calculation may be performed for the dependent claims in a patent.

The CRI factor can be generated for a single patent, all of the patents owned by a company in a certain patent classification, or on the company's patent portfolio as a whole to arrive at an overall corporate CRI value.

In addition, a CRI value may be generated to assess the relative strength of the method, apparatus or article of manufacture claims in a patent. To assess the method claims, the number of steps in each method claim is determined, summed and then divided by the total number of method claims to arrive at a number representing the average number of steps per method claim. This may be represented by the following equation:

$$C R {I}_{m e t h o d c l a i m s} = \frac{\sum ( Number of steps in all method claims )}{Total number of method claims}$$

As a general principle, the addition of steps to a method claim generally tends to decrease the scope of such a claim, in that the additional steps are often limitations that decrease the likelihood of broad exclusionary patent rights. Thus, low CRI values for method claims generally indicate broader patent rights and high CRI values indicate narrower patent rights.

A similar analysis may be conducted for apparatus, article of manufacture and composition of matter claims except that the number of elements per claim are analyzed instead of the number of steps, as follows:

$$C R {I}_{a p p a r a t u s c l a i m s} = \frac{\sum ( Number of elements in all a p p a r a t u s claims )}{Total number of a p p a r a t u s claims}$$

Again, lower values for CRI_{apparatus claims} tend to indicate broader patent rights and higher values tend to indicate narrower patent rights.

At this point a variety of CRI factors may have been generated, such as

CRI_{independent claims}

CRI_{dependent claims}

CRI_{method claims}

CRI_{apparatus claims}

CRI_{article of manufacture claims}, etc.

These CRI factors may then be output in the form of a report record 28 for use by an analyst or other user in assessing a company's patent portfolio. In the alternative, the CRI factors may be transferred to arithmetic logic circuit 70. Arithmetic logic circuit 70 is configured to perform calculations on the frequency of the use of structural claim language versus functional claim language in each patent claim. Typically, functional claim language affords broader patent coverage than structural claim language. Each use of functional claim language is known as a functional limitation; each use of structural claim language is known as a structural limitation. Hence, logic circuit 70 calculates the frequency of the use of functional language in each patent claim of a patent. This information can be calculated for each of the various CRI factors referenced above and a weighting factor μ can be assigned for each CRI factor. Weighting factor μ may be generated in a variety of fashions. Generally, however, the weighting factor may be generated for a given patent as follows:

$$μ = \frac{\begin{matrix}( total number of structural limitations \\ in patent claims )\end{matrix}}{\begin{matrix}( total number of structural and functional \\ limitations in patent claims ) \end{matrix}}$$

In the absence of any functional limitations in the patent claims, μ is equal to a value of one. The greater the number of functional limitations, the lower the value of μ. As discussed before, the lower the value of μ, generally, the broader the scope of patent coverage.

The values for CRI and μ may then be multiplied to obtain an Adjusted CRI for the independent claims of a patent n, or a patent portfolio n, as follows:

Adjusted CRIₙ=μₙ^{φ}CRI_{independent claims n}

where ψ is a weighting exponent that is adjusted based on the particulars of the patent or patent portfolio under study. Different values of exponent ψ may be used and adjusted depending on the technology or market area covered by the patent, or can be calculated through optimization techniques. It can be readily seen that a low value for μₙ^{ψ} and a low value for CRI_{independent claims n} will lead to a lower Adjusted CRI for patent n. In other terms, if there is a high frequency of functional limitations (low μₙ^{ψ}) and a low average number of words (low CRI_{independent claims n}), the lower Adjusted CRI correlates to broader patent coverage. In a similar fashion, Adjusted CRI values may also be generated for the following CRI indexes discussed above though the application of appropriate μₙ^{ψ} factors for each particular subclass of CRI factors, thus leading to the calculation of

Adjusted CRI_{independent claims}

Adjusted CRI_{dependent claims}

Adjusted CRI_{method claims}

Adjusted CRI_{apparatus claims}

Adjusted CRI_{article of manufacture claims}, etc.

These CRI factors may then be output in the form of a report record 28 for use by an analyst in assessing a company's patent or entire patent portfolio. In the alternative, the CRI factors may be transferred to arithmetic logic circuit 72. Logic circuit 72 is configured to generate a weighting factor Φₙ for use in further adjusting CRI values. The weighting factor Φₙ represents the frequency and extent of amendments made to the claims of a patent n or each patent in a patent portfolio n during the prosecution of a patent application before the USPTO, or similar foreign agency.

Patent prosecution is a term used to describe the patent application process. In a typical situation, an applicant for a patent will prepare and file a patent application with the USPTO. In a utility patent application, the application includes at least one claim that describes and claims the applicant's invention. The patent is then examined by an examiner of the USPTO for compliance with a variety of statutory requirements prior to allowing a patent to issue. For instance, a patent examiner may reject the claims contained in the application on the grounds that the invention is anticipated by a prior art reference (35 U.S.C. §102(b)) or on the grounds that the invention would have been obvious to one of ordinary skill in the art at the time the invention was made (35 U.S.C. §103). An applicant must respond to such rejections and may do so through the use of arguments to distinguish the prior art cited by the patent examiner, or by amending the claims of the pending application so as to overcome the patent examiner's rejection. If satisfied, the patent examiner will then allow the patent application to issue as a patent. As a practical matter, amendments to the claims during prosecution have several consequences for the patent applicant. First, the literal language of the amended claims is altered, and generally narrowed through the amendment process. This leads to a patent having a narrower scope. Similarly, at such time as the owner of a patent attempts to enforce its patent against a potential infringer in a patent infringement legal action, any amendments to the claims made in prosecution are generally held against the patent holder, and thus the patent holder is estopped from claiming a more expansive interpretation of the literal words of the patent claim. This doctrine is known as prosecution estoppel, and it narrows the scope of patent coverage.

It is thus useful to determine the frequency and extent of amendments to patent claims made during the patent application prosecution and adjust weighting factor Φₙ accordingly. A high frequency of claim amendments tends to indicate patent claims having a narrower scope of coverage, and a low frequency of claim amendments tends to indicate patent claims having a broader scope of coverage. Weighting factor Φₙ may be calculated in a variety of fashions. One such manner of calculations is as follows, for the claims of a patent n, or a patent portfolio n:

$${Φ}_{n} = \frac{\begin{matrix}( total number of words in amended patent \\ claims ) \times {( number of amendments filed )}^{λ}\end{matrix}}{\begin{matrix}( total number of words \\ in unamended patent claims )\end{matrix}}$$

where λ is a weighting exponent that is adjusted based on the particulars of the patent or patent portfolio under study. Different values of exponent λ may be used and adjusted depending on the technology or market area covered by the patent, or can be calculated through optimization techniques. Any other number of statistical tools well known to those of ordinary skill in the art could be used to determine Φₙ.

The values for CRI, μₙ and Φₙ may then be combined to obtain an Overall Adjusted CRI for the independent claims of a patent n, or a patent portfolio n as follows:

Overall Adjusted CRIₙ=μₙ^{ψ}Φₙ^{γ}CRI_{independent claims n}

where γ is a weighting exponent that is adjusted based on the particulars of the patent or patent portfolio under study and

where n is a particular patent or patent portfolio under analysis.

Different values of exponent γ may be used and adjusted depending on the technology or market area covered by the patent, or can be calculated through optimization techniques. It can be readily seen that lower values for μₙ^{ψ}, Φₙ^{γ} and CRI_{independent claims n} will lead to a lower Overall Adjusted CRIₙ. In other terms, if there is a high frequency of functional limitations (low μₙ^{ψ}), a low frequency of amendments to the patent claims during prosecution (low Φₙ^{γ}) and a low average number of words (low CRI_{independent claims n}), the Overall Adjusted CRIₙ correlates to broader patent coverage.

In a similar fashion, Overall Adjusted CRI values may be generated for the CRI indices discussed above through the application of appropriate μₙ^{φ} and Φₙ^{γ} factors for each particular subclass of CRI factors, thus leading to the calculation of Overall Adjusted CRI for independent claims, dependent claims, method claims, apparatus claims, etc. This method may be used to assess a single patent, a portion of a patent portfolio, or the entire patent portfolio of a company, and it is readily apparent that peer group comparisons could be performed for Overall Adjusted CRI.

Weighting factors μₙ and Φₙ may be combined with various CRI factors, or may be used independently, or in combination with one another to assess a patent, or a patent portfolio.

The various Adjusted CRI values may then be output in the form of a report record 28 for use by an analyst in assessing a company's patent portfolio or for further use as discussed below.

FIG. 11 depicts a block diagram of the arithmetic logic circuit of a computer software program and processor 40 configured and arranged to calculate a factor known as the Patent Strength of a company's patent portfolio, or individual patent owned by a company. The first step is similar to the initial step shown in FIG. 4 and involves a user inputting certain information pertaining to a patent that the user desires to analyze. Arithmetic logic circuit 74 rates the strength of each patent claim for the desired patent on a scale of 1-100, with a value of 100 corresponding to the greatest patent strength, and a value of 1 corresponding to the weakest patent strength. Arithmetic logic circuit 74 draws upon a patent practitioner's professional assessment of a number of factors, such as the state of the prior art, anticipated validity of the claim, scope of the claim, pending litigation, and other factors which tend to increase or decrease the relative strength of a patent claim. This information is directly input 76. In addition, or in the alternative, Overall Adjusted CRIₙ values 73 calculated for patent portfolio n may be introduced and weighted appropriately with the practitioner's knowledge (or used separately) to develop a rating. Other factors that can be used in developing a rating include, but are not limited to Future Patent Power, Patent Years, Average Patent Term, percentage of lapsed patents in a company's patent portfolio, percentage of patent applications pending in a company's patent portfolio, percentage of patents that have been invalidated in a company's patent portfolio, percentage of patents in a company's patent portfolio that have been involved in litigation.

The software then uses arithmetic logic circuit 75 to rate the strength of the market demand for each patent claim for the desired patent on a scale of 1-100, with a value of 100 corresponding to the greatest market demand, and a value of 1 corresponding to the least market demand. Arithmetic logic circuit 75 draws upon a market analyst's professional economic assessment of a number of factors, such as demand for the claimed invention, present market share controlled by the patent owner or licensee, marketing channels, future growth potential, alternate or substitute goods or technologies, obsolescence and market timing, as well as other factors which tend to increase or decrease market demand for the claimed invention. This information is directly input 77.

The present invention then performs a summation operation of the product of market strength times Claim strength through the use of logic circuit 78 to obtain an average Patent Strength value for a patent n, or a patent portfolio n containing k patent claims in accordance with the following equation:

$$Patent Strength = {\sum }_{i = 1}^{k} ( Claim {Strength}_{i} \times Market {Demand}_{i} )$$

where k=the total number of patent claims being assessed; and

where i is a counter that ranges from 1 to k.

This information may then be compared to peer group data 31, and other comparisons may be performed on the data as described heretofore. Trends and correlations 79, 80 may be assessed and determined by comparing Patent Strength to well known financial indicators such as Earnings per Share, P/E ratio, Return on Investment, Return on Assets, etc. In addition, Patent Strength may be viewed as a financial indicator 81 of its own accord, and comparisons may be performed between different companies or across different market segments to assess the overall technical strength of a company's patent portfolio. The results are then provided to market analysts, mutual fund managers, investors and other users 82 to assist in prudent investment decisions based on the patent portfolio of the company. Patent Strength may also be converted to a direct equity value number to assist in the valuation of the assets of a company through the use of normalization techniques well known to those of ordinary skill in the art and can then be compared to return on asset values among a given peer group. Return on asset values are generally well known for publicly traded companies.

In addition, the present invention contemplates the provision of an ongoing service 83 to market analysts and other users whereby intellectual property reports, and reports on factors such as Patent Years, Future Patent Power, CRI and Patent Strength can be generated on a regular and ongoing basis for each patent that issues for a particular company in the future. This would be provided in the form of a subscription service for companies in selected market sectors.

The present invention may be embodied in a computer program product for assessing the value of a company's patent portfolio. The computer program product comprises a computer executable program that is executed on a computer processor. The computer executable program is embedded in a tangible medium. The tangible medium may include cd ROMs, magnetic tapes, floppy disks, hard disks, and computer tapes. The computer executable program is configured and arranged to cause the computer processor to determine a variety of patent indicators as discussed heretofore. These patent indicators may include Overall Adjusted Claim Ratio Index, Claim Ratio Index, Future Patent Power, Patent Years, Average Patent Term, Patent Strength, percentage of lapsed patents in a company's patent portfolio, percentage of patent applications pending in a company's patent portfolio, percentage of patents that have been invalidated in a company's patent portfolio, and percentage of patents in a company's patent portfolio that have been involved in litigation.

Therefore, while the presently-referred form of the invention has been shown and described, and several modifications thereof discussed, persons of ordinary skill in this art will readily appreciate that various additional changes and modifications may be made without departing from the spirit of the invention, as defined and differentiated by the following claims, and the following claims are intended to cover all such other changes, modifications and embodiments of the present invention.

We claim:

1. A method for assessing intellectual property comprising:
gathering intellectual property data;
performing an assessment of the intellectual property data; and
generating a report based on the assessment of the intellectual property data.

2. The method according to claim 1 wherein said intellectual property data is selected from the group consisting of the following: U.S. utility patents, U.S. plant patents, U.S. reissue patents, U.S reexamination patents, pending U.S. patent applications (including divisionals, continuations, continuations in part, continuing applications, continuing examination applications, requested continued examination applications), international patents of any type, pending foreign patent applications of any type, design patents, industrial designs, trademarks, servicemarks, intent to use trademarks, mask works, copyrights, pending trademark applications, licenses, patent licenses, cross licenses, trade secrets, know how, showhow, domain names, confidential materials owned by a company not publicly known, and any other aspect of intellectual property that gives a company a competitive edge, or otherwise enhances the value of a company.

3. The method according to claim 1 wherein the step of performing an assessment of the intellectual property data further comprises the step of assessing a plurality of intellectual property holdings with respect to prior art, competitors' products, processes and market demands.

4. The method according to claim 1 wherein the step of performing an assessment of the intellectual property data further comprises the step of performing a sensitivity analysis to determine changes in the intellectual property data.

5. The method according to claim 1 wherein the step of performing an assessment of the intellectual property data further comprises the step of performing a peer group analysis of a plurality of companies to compare the intellectual property data held by the companies.

6. The method according to claim 1 wherein the step of performing an assessment of the intellectual property data further comprises the step of performing a competitive analysis of a plurality of companies using the intellectual property data and market data.

7. The method according to claim 1 wherein the intellectual property data comprises patent data for a company.

8. The method according to claim 7 wherein the step of performing an assessment of the intellectual property data further comprises the step of calculating an Average Term for at least one patent owned by the company according to the equation:
$$Average Term = \frac{\begin{matrix}\sum Years remaining on patent term for each \\ patent being assessed\end{matrix}}{Number of patents being assessed} .$$

9. The method according to claim 8 further comprising the step of comparing the Average Term against research and development expenditures over time.

10. The method according to claim 9 further comprising the step of comparing the Average Term for the company against an Average Term for a second company.

11. The method according to claim 10 wherein the second company is a competitor of the company.

12. The method according to claim 7 wherein the step of performing an assessment of the intellectual property data further comprises the step of calculating Patent Years for at least one patent owned by the company according to the equation:
$$Patent Years = {\sum }_{i = 1}^{k} ( Years remaining on term of {patent}_{i} )$$
where k=the total number of patents being assessed in the company's patent portfolio and where i is a counter for counting the number of patents.

13. The method according to claim 12 further comprising the step of comparing the Patent Years against research and development expenditures over time.

14. The method according to claim 12 further comprising the step of comparing the Patent Years for the company against Patent Years for a second company and wherein the second company is a competitor of the company.

15. The method according to claim 12 further comprising the steps of:
plotting the Patent Years versus time;
generating a line based on the plot of the Patent Years versus time;
calculating an area under the line; and
determining a Future Patent Power, the Future Patent Power equal to the area under the line.

16. The method according to claim 15 wherein the step of calculating the area under the line is performed by mathematical integration and wherein said line is nonlinear.

17. The method according to claim 15 further comprising the step of calculating the rate of change in the Future Patent Power with respect to time.

18. The method according to claim 15 further comprising the step of comparing the Future Patent Power against research and development expenditures over time.

19. The method according to claim 15 further comprising the step of comparing the Future Patent Power for the company against a Future Patent Power for a second company and wherein the second company is a competitor of the company.

20. The method according to claim 7 wherein the step of performing an assessment of the intellectual property data further comprises the step of calculating a percentage of lapsed patents by dividing the number of lapsed patents by the total number of patents in the company's patent portfolio.

21. The method according to claim 7 wherein the step of performing an assessment of the intellectual property data further comprises the step of calculating a percentage of patent applications pending by dividing the number of patent applications pending by the total number of patents in the company's patent portfolio.

22. The method according to claim 7 wherein the step of performing an assessment of the intellectual property data further comprises the step of calculating a percentage of patents that have been invalidated in the company's patent portfolio.

23. The method according to claim 7 wherein the step of performing an assessment of the intellectual property data further comprises the step of calculating a percentage of patents in the company's patent portfolio that have been involved in litigation.

24. The method according to claim 7 further comprising the step of performing a comparison, the comparison selected from the group consisting of: percentage of lapsed patents in the company's patent portfolio versus research and development expenditures over time, percentage of patent applications pending in the company's patent portfolio versus research and development expenditures over time, percentage of patents that have been invalidated in the company's patent portfolio versus research and development expenditures over time, and percentage of patents in the company's patent portfolio that have been involved in litigation versus research and development expenditures over time.

25. The method according to claim 7 further comprising the step of performing a comparison for the company, the comparison selected from the group consisting of: percentage of lapsed patents in the company's patent portfolio versus percentage of lapsed patents in a second company's patent portfolio, percentage of patent applications pending in the company's patent portfolio versus percentage of patent applications pending in a second company's patent portfolio, percentage of patents that have been invalidated in the company's patent portfolio versus percentage of patents that have been invalidated in a second company's patent portfolio, and percentage of patents in the company's patent portfolio that have been involved in litigation versus percentage of patents in a second company's patent portfolio that have been involved in litigation.

26. The method according to claim 7 further comprising the steps of:
identifying at least one inventor having assigned at least one patent to the company;
determining a percentage of the company's patent portfolio invented by the inventor; and
identifying the assignment of at least one invention made by the inventor to a second company.

27. The method according to claim 7 wherein the step of performing an assessment of the intellectual property data further comprises the step of calculating the percentage of patents held by the company in at least one patent class.

28. The method according to claim 7 wherein the company is an insured party and further comprising the steps of:
calculating a modification factor for use in issuing a patent insurance policy to the insured party;
providing the modification factor to an insurer; and
using the modification factor to determine the applicable terms of the patent insurance policy.

29. The method according to claim 28 wherein the modification factor is calculated according to the equation:
$$Modification Factor = {\sum }_{i = 1}^{k} ( {α}_{i} ) ( {X}_{i} )$$
where k=the total number of patent factors being assessed in a company's patent portfolio;
where i is a counter for counting the number of patent factors;
where αᵢ is a weighting coefficient determined by the type of industry, level of technology, and business activities of the insured party; and
where Xᵢ is a patent factor for the insured party selected from the group consisting of: Patent Years, Future Patent Power, Average Patent Term, CRI and Patent Strength.

30. The method according to claim 7 wherein the step of performing an assessment of the intellectual property data further comprises the step of calculating a Claim Ratio Index for at least one patent claim.

31. The method according to claim 30 wherein the Claim Ratio Index is calculated for a plurality of patent claims according to the equation:
$${CRI}_{claims} = \frac{\sum ( Number of words in the claims )}{Total number of claims} .$$

32. The method according to claim 31 wherein the claims comprise at least one independent claim.

33. The method according to claim 31 wherein the claims comprise at least one dependent claim.

34. The method according to claim 31 wherein the claims comprise at least one method claim.

35. The method according to claim 31 wherein the claims comprise at least one apparatus claim.

36. The method according to claim 31 wherein the claims comprise at least one article of manufacture claim.

37. The method according to claim 31 wherein the Claim Ratio Index is adjusted by the use of at least one weighting factor to generate an Overall Adjusted Claim Ratio Index according to the equation:
Overall Adjusted CRIₙ=μₙ^{ψ}Φₙ^{γ}CRI_{claims n}
where
$${μ}_{n} = \frac{( total number of structural limitations in the claims )}{\begin{matrix}( total number of structural and functional \\ limitations in the claims )\end{matrix}} ;$$
ψ is a weighting exponent that is adjusted based on the particulars of the patent or patent portfolio under study and used to adjust the value of μₙ;
$${Φ}_{n} = \frac{\begin{matrix}( total number of words in amended claims ) \times \\ {( number of amendments filed )}^{λ}\end{matrix}}{( total number of words in unamended claims )} ;$$
where λ is a weighting exponent that is adjusted based on the particulars of the patent or patent portfolio under study;
γ is a weighting exponent that is adjusted based on the particulars of the patent or patent portfolio under study and used to adjust the value of Φₙ; and
n represents the particular patent or patent portfolio under analysis.

38. The method according to claim 37 wherein a greater value of the Overall Adjusted Claim Ratio Index, μₙ^{ψ} and Φₙ^{γ} correlate to broader patent coverage and wherein a lesser value of the Overall Adjusted Claim Ratio Index, μₙ^{ψ} and Φₙ^{γ} correlate to narrower patent coverage.

39. The method according to claim 37 wherein the Overall Adjusted Claim Ratio Index is calculated for at least one of the following selected from the group consisting of: a single patent, a portfolio of patents, a portion of a portfolio of patents, independent claims, dependent claims, method claims, apparatus claims and article of manufacture claims.

40. The method according to claim 37 further comprising the step of comparing the Overall Adjusted Claim Ratio Index for the company against an Overall Adjusted Claim Ratio Index for a second company and wherein the second company is a competitor of the company.

41. The method of claim 1 wherein the steps are performed by using a plurality of computer executable instructions being executed on a computer processing system.

42. The method according to claim 7 wherein the step of performing an assessment of the intellectual property data further comprises the step of calculating a Patent Strength.

43. The method according to claim 42 wherein the Patent Strength is calculated according to the equation:
$$Patent Strength = {\sum }_{i = 1}^{k} ( Claim {Strength}_{i} \times Market {Demand}_{i} )$$
where k=the total number of patent claims being assessed;
i is a counter that ranges from 1 to k for counting the number of patent claims;
where Claim Strength is a numerical representation of the strength of a patent claim and is calculated and adjusted using at least one of the following selected from the group comprising: Overall Adjusted Claim Ratio Index, Claim Ratio Index, Future Patent Power, Patent Years, Average Patent Term, percentage of lapsed patents in the company's patent portfolio, percentage of patent applications pending in the company's patent portfolio, percentage of patents that have been invalidated in the company's patent portfolio, percentage of patents in the company's patent portfolio that have been involved in litigation, prior art, claim scope, validity and professional assessment;
where Market Strength is a numerical representation of the market demand for the claimed invention and is calculated and adjusted using at least one of the following selected from the group consisting of: demand for the claimed invention, present market share controlled by a patent owner or licensee, marketing channels, future growth potential, alternate goods, substitute goods, alternate technologies, obsolescence, market timing, and other factors which tend to increase or decrease the market demand for the claimed invention; and
wherein a higher value of the Patent Strength correlates to a higher market value and wherein a lower value of the Patent Strength correlates to a lower market value.

44. The method according to claim 43 further comprising the step of using the value of the Patent Strength as a financial indicator.

45. The method according to claim 44 wherein the Patent Strength is compared to at least one of the following selected from the group consisting of: research and development expenditures, Patent Strength values for members of the company's peer group, earnings per share data, stock price, P/E ratio data, Return on Asset data and Return on Investment data.

46. The method according to claim 44 wherein the Patent Strength is converted to an equity value used in assessing the overall assets of the company.

47. The method according to claim 46 wherein the Patent Strength is converted to an equity value using a normalization technique.

48. A computerized system for assessing intellectual property comprising:
means for gathering intellectual property data;
means for performing an assessment of the intellectual property data; and
means for generating a report based on the assessment of the intellectual property data.

49. The system according to claim 48 wherein the means for performing an assessment of the intellectual property data further comprises means for assessing a plurality of intellectual property holdings with respect to prior art, competitor's products, processes and market demands.

50. The system according to claim 48 wherein the means for performing an assessment of the intellectual property data further comprises means for performing a peer group analysis of a plurality of companies to compare the intellectual property data held by the companies.

51. The system according to claim 48 wherein the means for performing an assessment of the intellectual property data further comprises means for performing a competitive analysis of a plurality of companies using the intellectual property data and market data.

52. The system according to claim 48 wherein the intellectual property data comprises patent data for a company.

53. The system according to claim 52 wherein the means for performing an assessment of the intellectual property data further comprises means for calculating an Average Term for at least one patent owned by the company according to the equation:
$$Average Term = \frac{\begin{matrix}\sum Years remaining on patent term \\ for each patent being assessed\end{matrix}}{Number of patents being assessed} .$$

54. The system according to claim 52 wherein the means for performing an assessment of the intellectual property data further comprises means for calculating Patent Years for at least one patent owned by the company according to the equation:
$$Patent Years = {\sum }_{i = 1}^{k} ( Years remaining on term of {patent}_{i} )$$
where k=the total number of patents being assessed in the company's patent portfolio and where i is a counter for counting the number of patents.

55. The system according to claim 54 further comprising:
means for plotting the Patent Years versus time;
means for generating a line based on the plot of the Patent Years versus time;
means for calculating an area under the line; and
means for determining a Future Patent Power, the Future Patent Power equal to the area under the line.

56. The system according to claim 52 wherein the company is an insured party and further comprising:
means for calculating a modification factor for use in issuing a patent insurance policy to the insured party;
means for providing the modification factor to an insurer; and
means for using the modification factor to determine the applicable terms of the patent insurance policy.

57. The system according to claim 56 wherein the modification factor is calculated according to the equation:
$$Modification Factor = {\sum }_{i = 1}^{k} ( {α}_{i} ) ( {X}_{i} )$$
where k=the total number of patent factors being assessed in a company's patent portfolio;
where i is a counter for counting the number of patent factors;
where αᵢ is a weighting coefficient determined by the type of industry, level of technology, and business activities of the insured party; and
where Xᵢ is a patent factor for the insured party selected from the group consisting of: Patent Years, Future Patent Power, Average Patent Term, CRI and Patent Strength.

58. The system according to claim 52 wherein the means for performing an assessment of the intellectual property data further comprises means for calculating a Claim Ratio Index for at least one patent claim.

59. The system according to claim 58 wherein the Claim Ratio Index is calculated for a plurality of patent claims according to the equation:
$${CRI}_{claims} = \frac{\sum ( Number of words in the claims )}{Total number of claims} .$$

60. The system according to claim 59 wherein the Claim Ratio Index is adjusted by the use of at least one weighting factor to generate an Overall Adjusted Claim Ratio Index according to the equation:
Overall Adjusted CRIₙ=μₙ^{ψ}Φₙ^{γ}CRI_{claims n}
where
$${μ}_{n} = \frac{\text{(total number of structural limitations in the claims)}}{\begin{matrix}\text{(total number of structural and} \\ \text{functional limitations in the claims)}\end{matrix}} ;$$
ψ is a weighting exponent that is adjusted based on the particulars of the patent or patent portfolio under study and used to adjust the value of μₙ;
$${Φ}_{n} = \frac{\begin{matrix}( total number of words in amended claims ) \times \\ {( number of amendments filed )}^{λ}\end{matrix}}{( total number of words in unamended claims )} ;$$
where λ is a weighting exponent that is adjusted based on the particulars of the patent or patent portfolio under study;
γ is a weighting exponent that is adjusted based on the particulars of the patent or patent portfolio under study and used to adjust the value of Φₙ; and
n represents the particular patent or patent portfolio under analysis.

61. The system according to claim 60 wherein a greater value of the Overall Adjusted Claim Ratio Index, μₙ^{ψ} and Φₙ^{γ} correlate to broader patent coverage and wherein a lesser value of the Overall Adjusted Claim Ratio Index, μₙ^{ψ} and Φₙ^{γ} correlate to narrower patent coverage.

62. The system according to claim 60 wherein the Overall Adjusted Claim Ratio Index is calculated for at least one of the following selected from the group consisting of: a single patent, a portfolio of patents, a portion of a portfolio of patents, independent claims, dependent claims, method claims, apparatus claims and article of manufacture claims.

63. The system according to claim 52 wherein the means for performing an assessment of the intellectual property data further comprises means for calculating a Patent Strength according to the equation:
$$Patent Strength = {\sum }_{i = 1}^{k} ( Claim {Strength}_{i} \times Market {Demand}_{i} )$$
where k=the total number of patent claims being assessed;
where i is a counter that ranges from 1 to k for counting the number of patent claims;
where Claim Strength is a numerical representation of the strength of a patent claim and is calculated and adjusted using at least one of the following selected from the group comprising: Overall Adjusted Claim Ratio Index, Claim Ratio Index, Future Patent Power, Patent Years, Average Patent Term, percentage of lapsed patents in the company's patent portfolio, percentage of patent applications pending in the company's patent portfolio, percentage of patents that have been invalidated in the company's patent portfolio, percentage of patents in the company's patent portfolio that have been involved in litigation, prior art, claim scope, validity and professional assessment;
where Market Strength is a numerical representation of the market demand for the claimed invention and is calculated and adjusted using at least one of the following selected from the group consisting of: demand for the claimed invention, present market share controlled by a patent owner or licensee, marketing channels, future growth potential, alternate goods, substitute goods, alternate technologies, obsolescence, market timing, and other factors which tend to increase or decrease the market demand for the claimed invention; and
wherein a higher value of the Patent Strength correlates to a higher market value and wherein a lower value of the Patent Strength correlates to a lower market value.

64. The system according to claim 63 further comprising means for using the value of the Patent Strength as a financial indicator.

65. The system according to claim 64 wherein the Patent Strength is compared to at least one of the following selected from the group consisting of: research and development expenditures, Patent Strength values for members of the company's peer group, earnings per share data, stock price, P/E ratio data, Return on Asset data and Return on Investment data.

66. The system according to claim 64 wherein the Patent Strength is converted to an equity value used in assessing the overall assets of the company.

67. The system according to claim 66 wherein the Patent Strength is converted to an equity value using a normalization technique.

68. A computer program product for assessing the value of a patent portfolio comprising:
a computer executable program for being executed on a computer processor, the computer executable program embedded in a tangible medium, the computer executable program configured and arranged to store and organize patent data, and the computer executable program configured and arranged to cause the computer processor to determine a patent indicator.

69. The computer program product of claim 68 wherein the tangible medium is selected from the group consisting of: cd ROMs, magnetic tapes, floppy disks, hard disks, and computer tapes, and wherein the computer executable program is configured and arranged to cause the computer processor to determine the patent indicator which is selected from the group consisting of: Overall Adjusted Claim Ratio Index, Claim Ratio Index, Future Patent Power, Patent Years, Patent Strength, Average Patent Term, percentage of lapsed patents in a patent portfolio, percentage of patent applications pending in a patent portfolio, percentage of patents that have been invalidated in a patent portfolio, and percentage of patents in a patent portfolio that have been involved in litigation.
